(19) United States
(12) Patent Application Publication
(10) Pub. No.: US 2021/0238006 A1
(43) Pub. Date: Aug. 5, 2021

(54) EXPANDABLE PIPE SPOOL

(71) Applicant: Jet Oilfield Services Inc., Dallas, TX (US)

(72) Inventors: Lorne Randall Moseley, Benton, LA (US); Robert Timothy Greer, Minden, LA (US)

(73) Assignee: Jet Oilfield Services Inc., Dallas, TX (US)

(21) Appl. No.: 16/779,030

(22) Filed: Jan. 31, 2020

(51) Int. Cl. B65H 75/24

(52) U.S. Cl. CPC B65H 75/243

(57) ABSTRACT

An expandable pipe spool operable to connect components of a hydrocarbon extraction assembly is provided. The expandable pipe spool includes a female pipe segment having an outer surface and an inner surface having at least one sealing groove; at least one fluid port on the outer surface of the female pipe segment for receiving a hydraulic fluid, the fluid port in fluid communication with the sealing grove; a male pipe segment having an outer surface receivable within the female pipe segment; a sealing member positioned within the sealing groove between the inner surface of the female pipe segment and the outer surface of the male pipe segment; and a fastening arrangement to lock the male pipe segment in a selected longitudinal position with respect to the female pipe segment.

### FILED OF THE INVENTION

The exemplary embodiments of present invention relate generally to an expandable pipe spool and, in particular, an expandable pipe spool for use in a hydrocarbon extraction assembly.

### BACKGROUND OF THE DISCLOSURE

With increased risk faced in the oil and gas fracturing or “frac” industry, there exists considerable demand for reducing equipment failures during high pressure fracturing operations. As the probability of failures increases with the number of fracturing components utilized, engineers and system designers typically design fracturing systems with as few components as possible.

A fluid connection assembly for coupling a zipper manifold to components of a fracturing wellhead (known as a “frac stack”) is particularly vulnerable to failure as the assembly oftentimes utilizes multiple pipe sections in parallel (typically six or seven lengths of pipe) to channel high pressure fracturing fluid from the manifold to the frac stack. Failure of any of these pipe sections may result in substantial downtime for repairs, leading to lost profits and increased costs. These issues may be addressed by replacing the multiple pipe sections with a single, larger section of pipe. This larger pipe, which is formed typically of multiple pipe segments or “pipe spools” coupled end to end, extends directly from a fixture of the manifold (such as cross, T, or 90-degree fixture) to the frac stack, thereby providing a path for fracturing fluid to flow from the manifold, through the frac stack and into a well head.

As zipper manifolds are not placed in standard locations relative to frac stacks, orientations and distances between manifolds and frac stacks vary among fracturing assemblies. To accommodate the varying orientations and distances, component manufacturers make available adjustable pipe spools for use in connection assemblies. An adjustable pipe spool enables a user to adjust one or more dimensions of the spool, such as length (in the case of expandable pipe spools) or angular orientation or “swivel” (in the case of right-angle pipe spools). These adjustable pipe spools permit on-site customization and adjustment of connection assemblies to ensure proper coupling between zipper manifolds and frac stacks of different fracturing assemblies.

A prior art expandable pipe spool typically includes cylindrical female and male segments, each with a longitudinal bore for receiving fracturing fluid. The outer surface of the male segment is configured to screwably engage with an inner circumferential surface of the female segment, thereby aligning the longitudinal bores of both segments to produce a single pipe spool with a continuous bore. The length of the pipe spool may be adjusted by rotating the male segment to either advance or retract the male segment with respect to the female segment, depending upon the direction of rotation.

When used in a connection assembly, the prior art expandable pipe spool is connected rigidly at both ends to other pipe spools or fixtures. For this reason, adjustment of the pipe spool's length requires that a user first disconnect at least one end of the pipe spool to permit free rotation of the male segment with respect to the female segment, and then reconnect the end(s) after completion of the adjustment. This process is time consuming and costly, especially during initial setup of a connection assembly or when multiple spools of a connection assembly require adjustment. Additional costs and downtime may be incurred when adjustments are required during a fracturing operation, in which case all fracturing operations must cease until completion of the adjustment. Prior art adjustable pipe spools are also prone to damage and leaks caused by improper alignment with respect to other spools and components of the zipper manifold and frac stack.

There is a need for an adjustable spool that addresses these and other disadvantages of the prior art.

### BRIEF SUMMARY OF THE DISCLOSURE

In accordance with various exemplary embodiments of the present disclosure, an expandable pipe spool is provided, for example, for use in a hydrocarbon extraction assembly, such as a fracturing system. The length of the expandable pipe spool may be adjusted by sliding a male pipe segment with respect to a female pipe segment, rather than by rotating the male pipe segment. In this way, the expandable pipe spool may be adjusted without first disconnecting other pipe spools or components from the expandable pipe spool. This not only reduces the time required for initial set-up of a connection assembly, but may also permit adjustment of the expandable pipe spool without requiring the cessation of hydrocarbon extraction activities, thereby leading to less downtime and increased profits.

In accordance with an exemplary embodiment of the subject disclosure, an expandable pipe spool is provided. The pipe spool includes a female pipe segment having an outer surface and an inner surface having at least one sealing groove; at least one fluid port on the outer surface of the female pipe segment for receiving a hydraulic fluid, the fluid port in fluid communication with the sealing grove; a male pipe segment having an outer surface receivable within the female pipe segment; a sealing member positioned within the sealing groove between the inner surface of the female pipe segment and the outer surface of the male pipe segment; and a fastening arrangement to lock the male pipe segment in a selected longitudinal position with respect to the female pipe segment.

In accordance with another embodiment of the subject disclosure, the inner surface of the female pipe segment includes a first circumferential inner surface defining a first internal bore and a second circumferential surface defining a second internal bore, the second internal bore having a second diameter smaller than a first diameter of the first internal bore.

In accordance with still another embodiment of the subject disclosure, the at least one sealing groove includes two sealing grooves.

In accordance with yet another embodiment of the subject disclosure, the female pipe segment includes an end provided with fastening holes, the fastening holes being sized to receive fasteners to connect the female pipe segment to a component.

In accordance with still another embodiment of the subject disclosure, the male pipe segment includes a flange portion to engage with the fastening arrangement.

In accordance with yet another embodiment of the subject disclosure, the fastening arrangement includes at least one fastening stud extending through the flange portion of the male pipe segment and connected rigidly at an end of the female pipe segment.

In accordance with still another embodiment of the subject disclosure, the fastening arrangement further includes first and second nuts positioned on the fastening stud on respective sides of the flange portion of the male pipe segment.

In accordance with yet another embodiment of the subject disclosure, the male pipe segment includes an internal bore having a diameter approximately equal to the second diameter of the second internal bore of the female pipe segment.

In accordance with still another embodiment of the subject disclosure, the male pipe segment is structured to slidingly engage with the female pipe segment.

In accordance with yet another embodiment of the subject disclosure, a seal provided by the sealing member is improved when the hydraulic fluid flows under pressure from the fluid port into the sealing groove.

In accordance with still another embodiment of the subject disclosure, the sealing member includes a polymer, a metal, a composite or combinations thereof.

In accordance with yet another embodiment of the subject disclosure, the expandable pipe spool further includes a particulate shield between the inner surface of the female pipe segment and the outer surface of the male pipe segment.

In accordance with still another embodiment of the subject disclosure, the outer surface of the male pipe segment is provided with a particulate groove, the particulate shield positioned within the particulate groove.

In accordance with yet another embodiment of the subject disclosure, the expandable pipe spool further includes at least one drainage port on the outer surface of the female pipe segment for draining the hydraulic fluid, the drainage port in fluid communication with the sealing groove.

In accordance with still another embodiment of the subject disclosure, the sealing member is an annular sealing member.

In accordance with yet another embodiment of the subject disclosure, a method of adjusting a length of an expandable pipe spool is provided. The method includes inserting the male pipe segment within the female pipe segment; sliding the male pipe segment to the selected longitudinal position with respect to the female pipe segment; employing the fastening arrangement to lock the male pipe segment in the selected longitudinal position with respect to the female pipe segment; and injecting the hydraulic fluid into the sealing port to urge the sealing member against the outer surface of the male pipe segment to improve a seal between the male pipe segment and the female pipe segment.

### BRIEF DESCRIPTION OF THE SEVERAL VIEWS OF THE DRAWINGS

The foregoing summary, as well as the following detailed description of the exemplary embodiments of the subject disclosure, will be better understood when read in conjunction with the appended drawings. For the purpose of illustrating the present disclosure, there are shown in the figures exemplary embodiments. It should be understood, however, that the subject application is not limited to the precise arrangements and instrumentalities shown.

FIG. 1a is a cross-sectional view of an expandable pipe spool in a fully shortened position, in accordance with one embodiment of the subject disclosure;

FIG. 1b is a cross-sectional view of the expandable pipe spool of FIG. 1a in a fully expanded position, in accordance with one embodiment of the subject disclosure;

FIG. 1c is a perspective view of the expandable pipe spool of FIG. 1a, in accordance with one embodiment of the subject disclosure;

FIG. 1d is a cross-sectional perspective view of the expandable pipe spool of FIG. 1a, in accordance with one embodiment of the subject disclosure;

FIG. 2a is a cross-sectional view of a female pipe segment, in accordance with one embodiment of the subject disclosure;

FIG. 2b is a cross-sectional perspective view of the female pipe segment of FIG. 2a, in accordance with one embodiment of the subject disclosure;

FIG. 3a is a cross-sectional view of a male pipe segment, in accordance with one embodiment of the subject disclosure;

FIG. 3b is a cross-sectional perspective view of the male pipe segment of FIG. 3a, in accordance with one embodiment of the subject disclosure;

FIG. 4a is a cross-sectional detail view of the expandable pipe spool of FIG. 1a, in accordance with one embodiment of the subject disclosure; and

FIG. 4b is a cross-sectional detail view of the expandable pipe spool of FIG. 1a receiving a hydraulic fluid, in accordance with one embodiment of the subject disclosure.

### DETAILED DESCRIPTION OF THE DISCLOSURE

Reference will now be made in detail to the various exemplary embodiments of the subject disclosure illustrated in the accompanying figures. Wherever possible, the same or like reference numbers will be used throughout the figures to refer to the same or like features. It should be noted that the figures May not be drawn to precise scale. Certain terminology is used in the following description for convenience only and is not limiting. Directional terms such as top, bottom, left, right, above, below and diagonal, are used with respect to the accompanying figures. The term “distal” shall mean away from the center of a body. The term “proximal” shall mean closer towards the center of a body and/or away from the “distal” end. The words “inwardly” and “outwardly” refer to directions toward and away from, respectively, the geometric center of the identified element and designated parts thereof. Such directional terms used in conjunction with the following description of the figures should not be construed to limit the scope of the subject application in any manner not explicitly set forth. Additionally, the term “a,” as used in the specification, means “at least one.” The terminology includes the words above specifically mentioned, derivatives thereof, and words of similar import.

“About” as used herein when referring to a measurable value such as an amount, a temporal duration, and the like, is meant to encompass variations of ±20%, ±10%, ±5%, ±1%, or +0.1% from the specified value, as such variations are appropriate.

“Substantially” as used herein shall mean considerable in extent, largely but not wholly that which is specified, or an appropriate variation therefrom as is acceptable within the field of art.

Throughout the subject application, various aspects thereof may be presented in a range format. It should be understood that the description in range format is merely for convenience and brevity and should not be construed as an inflexible limitation on the scope of the subject disclosure. Accordingly, the description of a range should be considered to have specifically disclosed all the possible subranges as well as individual numerical values within that range. For example, description of a range such as from 1 to 6 should be considered to have specifically disclosed subranges such as from 1 to 3, from 1 to 4, from 1 to 5, from 2 to 4, from 2 to 6, from 3 to 6 etc., as well as individual numbers within that range, for example, 1, 2, 2.7, 3, 4, 5, 5.3, and 6. This applies regardless of the breadth of the range.

Furthermore, the described features, advantages and characteristics of the exemplary embodiments of the subject disclosure may be combined in any suitable manner into one or more embodiments. One skilled in the relevant art will recognize, in view of the description herein, that the subject disclosure can be practiced without one or more of the specific features or advantages of a particular exemplary embodiment. In other instances, additional features and advantages may be recognized in certain embodiments that may not be present in all exemplary embodiments of the present disclosure.

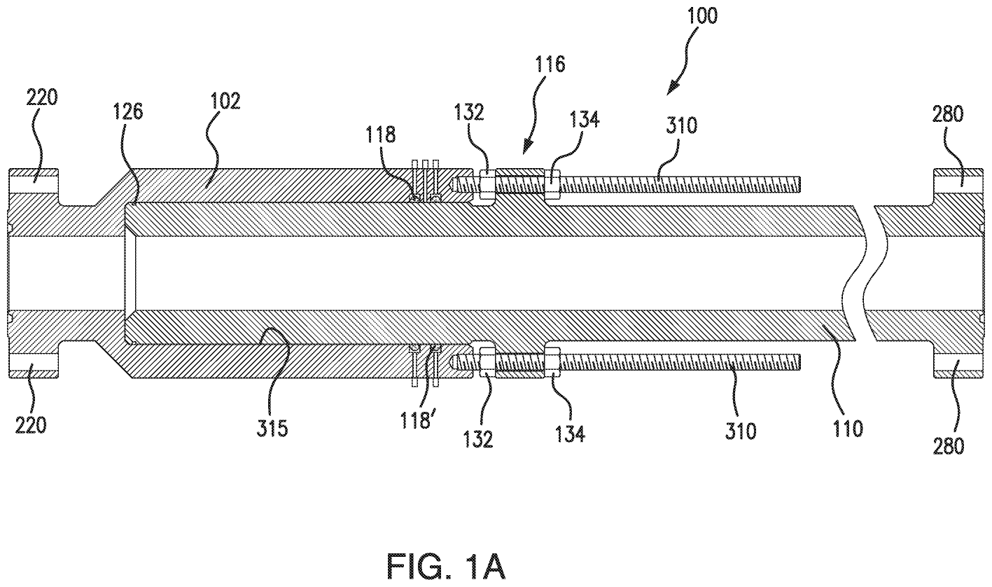

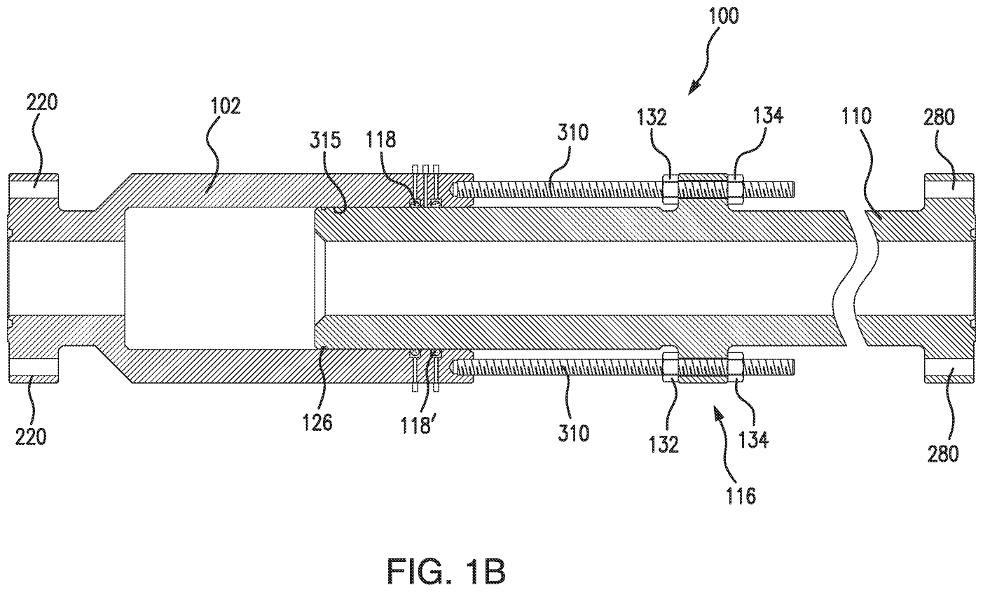

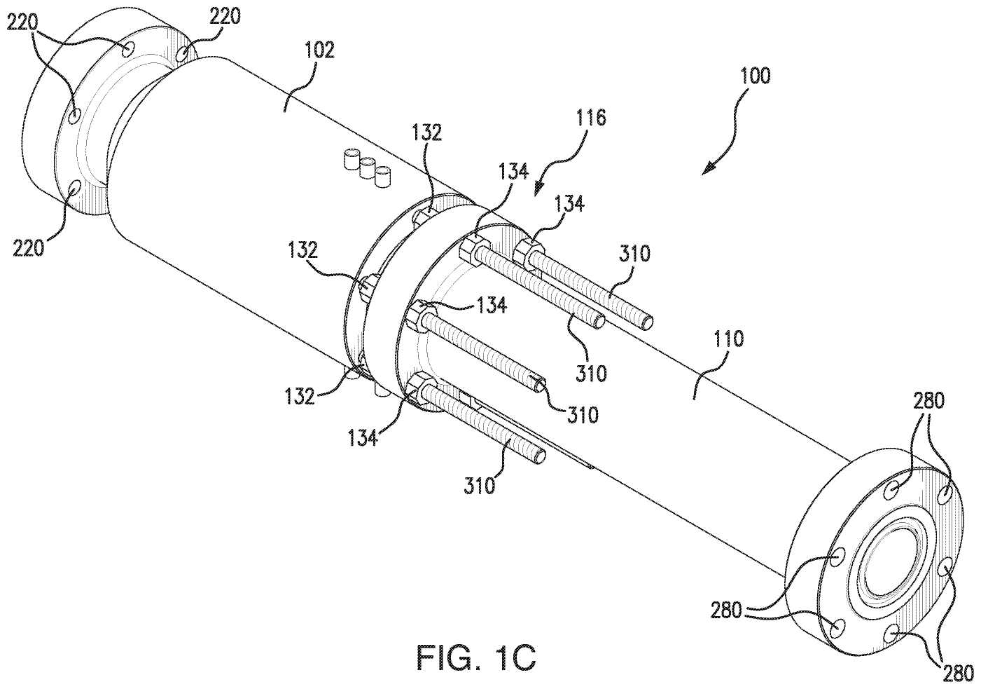

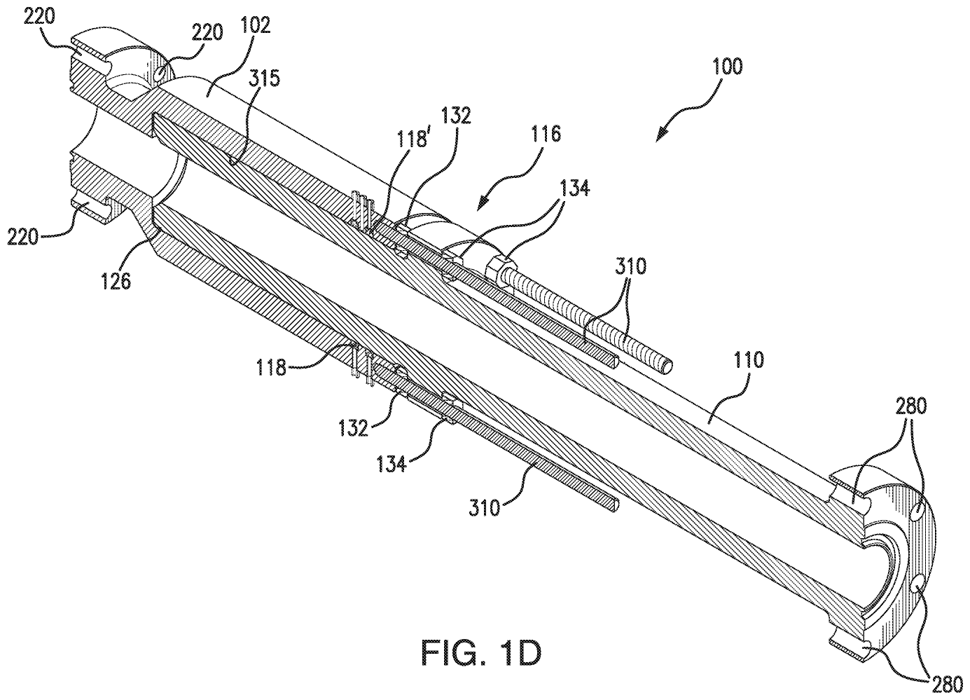

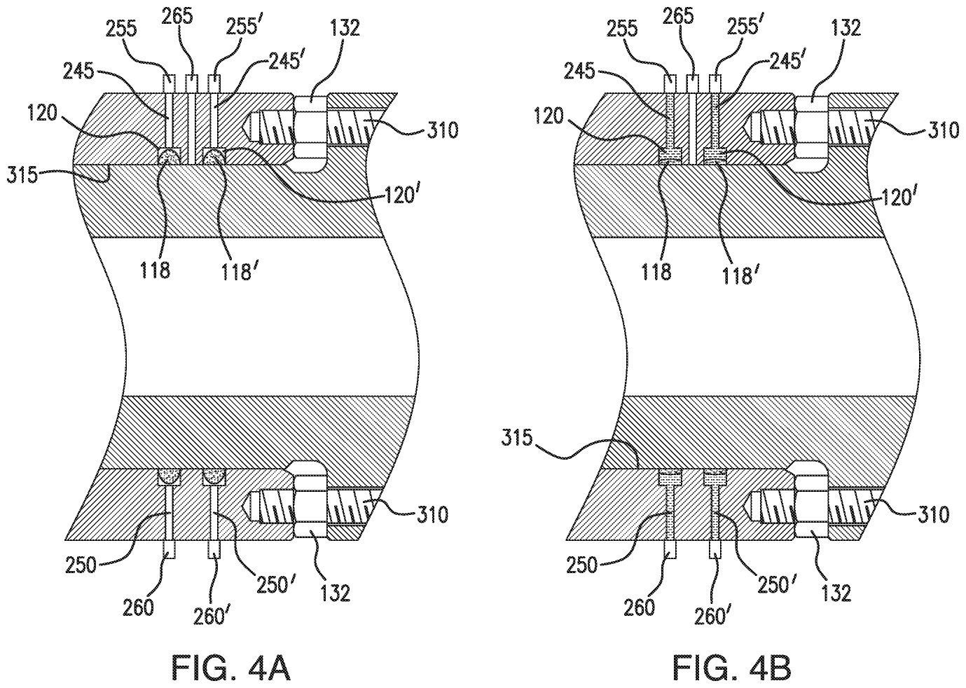

Referring now to FIGS. 1a through 1d and FIG. 4a, there is seen an expandable pipe spool 100 in accordance with an exemplary embodiment of the subject disclosure. Expandable pipe spool 100 includes a female pipe segment 102, a male pipe segment 110 slidingly positioned within female pipe segment 102, annular sealing members 118, 118′ (which may have arch-shaped cross-sections) and particulate shield 126 positioned between female and male pipe segments 102, 110, and a fastening arrangement 116 to lock male pipe segment 110 in a selected longitudinal position relative to female pipe segment 102. Expandable pipe spool 100 may be used in conjunction with other pipe spools and components to form a connection assembly for channeling fracturing fluid from a zipper manifold to a frac stack. To facilitate such a use and other uses, the length of expandable pipe spool 100 may be adjusted in a manner more fully described below.

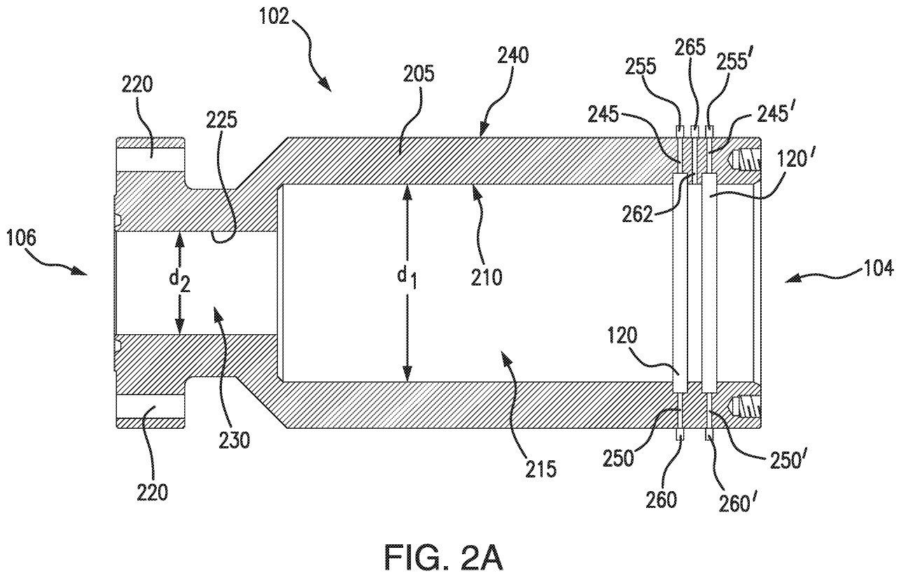

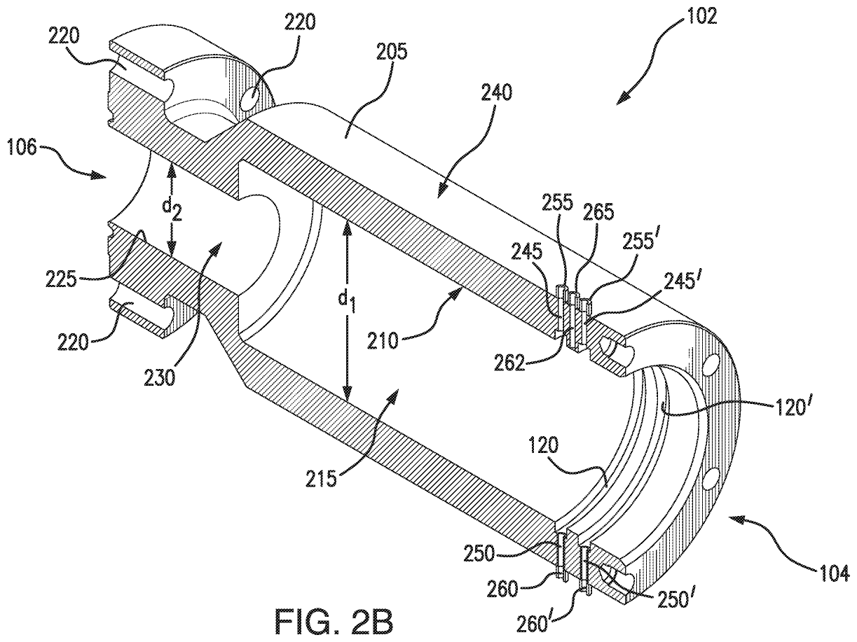

Referring now to FIGS. 2a and 2b, there is seen female pipe segment 102 of expandable pipe spool 100 in accordance with an exemplary embodiment of the subject disclosure. Female pipe segment 102 includes a cylindrical body 205 having a first end 104 and a second end 106 provided with a plurality of fastening holes 220 for coupling female pipe segment 102 via fasteners (not shown) to other pipe spools or components of a connection assembly. Cylindrical body 205 further includes an outer surface 240 and a first circumferential inner surface 210 defining a first internal bore 215 having a diameter d1 and a second circumferential inner surface 225 defining a second internal bore 230 coaxial with first internal bore 215 and having a diameter d2 smaller than diameter d1 of first internal bore 215. Circumferential inner surface 210 is also provided with two annual sealing grooves 120, 120′ for receiving respective sealing members 118, 118′. Cylindrical body 205 is further provided with fluid conduits 245, 245′ extending from fluid ports 255, 255′ on outer surface 240 (for example, one-way check valves, ball valves or the like) to sealing grooves 120, 120′ and drainage conduits 250, 250′ extending from drainage ports 260, 260′ on outer surface 240 to sealing grooves 120, 120′. A test conduit 262 is also provided and extends from a test port 265 on outer surface 240 to circumferential inner surface 210 between sealing grooves 120, 120′.

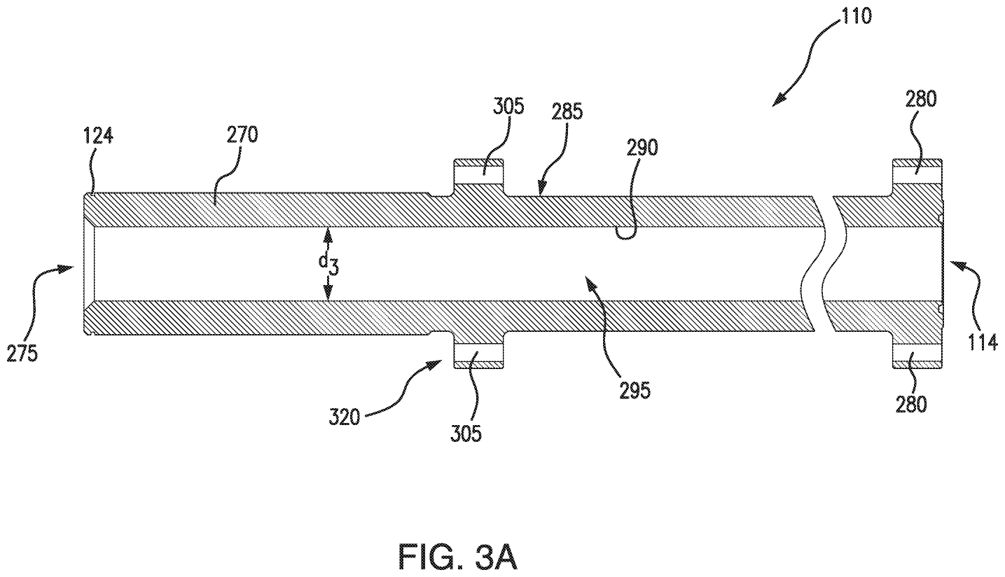

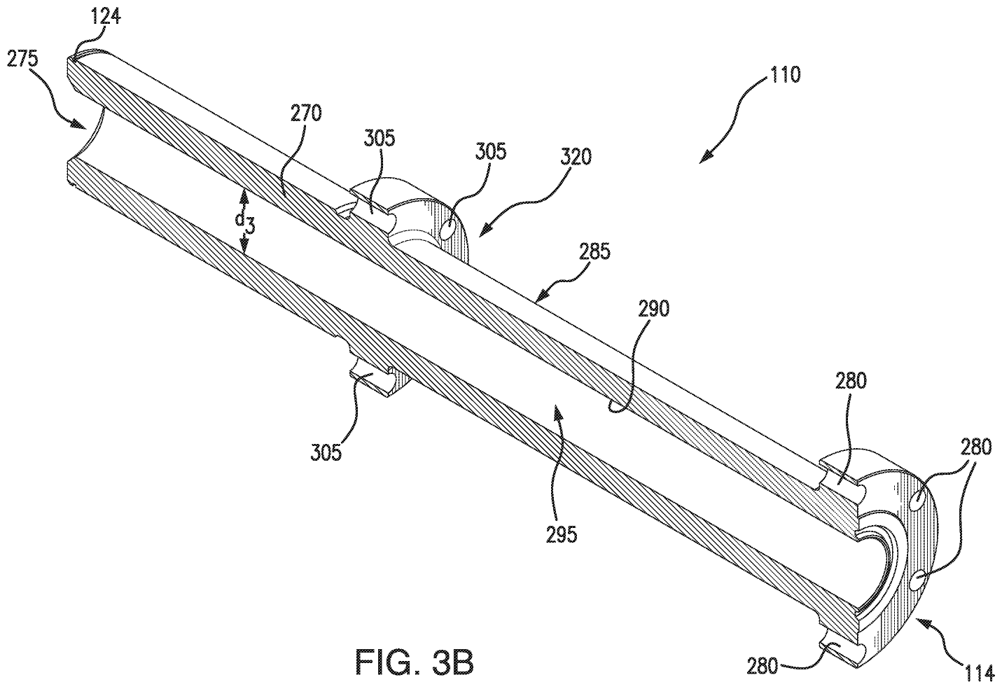

Referring now to FIGS. 3a and 3b, there is seen male pipe segment 110 of expandable pipe spool 100 in accordance with an exemplary embodiment of the subject disclosure. Male pipe segment 110 includes a cylindrical male body 270 having a first end 275 and a second end 114 provided with a plurality of fastening holes 280 for coupling male pipe segment 110 via fasteners (not shown) to other pipe spools or components of a connection assembly. Cylindrical male body 270 further includes an outer surface 285 and a circumferential inner surface 290 defining an internal bore 295 approximately coaxial with second internal bore 230 of female pipe segment 102 and having a diameter d3 approximately equal to diameter d2 of second internal bore 230, though it should be appreciated that diameter d3 need not approximate diameter d2. Outer surface 285 of cylindrical male body 270 also includes an annular particulate groove 124 at first end 275 for receiving particulate shield 126 and a flange portion 320 (which may be annular and/or non-continuous) having a plurality of unthreaded bores 305 for engaging fastening arrangement 116.

Outer surface 285 of cylindrical male body 270 has a diameter approximately equal to (but slightly less) than diameter d1 of first internal bore 215 of female pipe segment 102. This permits sealing members 118, 118′ to provide a fluid tight seal, while at the same time allowing first internal bore 215 of female pipe segment 102 to slidingly receive male pipe segment 110 so that male pipe segment 110 may be positioned at a selected longitudinal position relative to female pipe segment 102 for changing the length of expandable pipe spool 100 to a desired length.

Fastening arrangement 116 operates to lock male pipe segment 110 in the selected longitudinal position relative to female pipe segment 102. For this purpose, fastening arrangement 116 includes one or more fastening studs 310 extending respectively through unthreaded bores 305 of flange portion 320 and terminating fixedly within first end 104 of female pipe segment 102. Fastening arrangement 116 further includes first and second nuts 132, 134 threadedly engaged with each fastening stud 310 on respective sides of flange portion 320.

To increase the length of expandable pipe spool 100, second nuts 134 are loosened on (and possibly removed from) fastening studs 310. Male pipe segment 110 is then slid longitudinally away from female pipe segment 102 to a desired longitudinal position relative to female pipe segment 102. As best seen in FIG. 1b, once in the desired longitudinal position, first and second nuts 132, 134 are re-tightened to engage respective sides of flange portion 320, thereby locking male pipe segment 110 in the desired longitudinal position. To decrease the length of expandable pipe spool 100, first nuts 132 are loosened on fastening studs 310. Male pipe segment 110 is then slid longitudinally toward female pipe segment to a desired longitudinal position relative to female pipe segment 102. As best seen in FIG. 1a, once in the desired longitudinal position, first and second nuts 132, 134 are re-tightened to engage respective sides of flange portion 320, thereby locking male pipe segment 110 in the desired longitudinal position. Although fastening arrangement 116 includes fastening studs 310 and nuts 132, 134, it should be appreciated that fastening arrangement 116 may include or comprise other locking structures (such as a J-lock or other connector), and that various embodiments of the subject disclosure are not intended to be limited to any particular structure or mechanism for locking male pipe segment 110 to female pipe segment 102.

When expandable pipe spool 100 is used in a connection assembly, internal bore 295 of male pipe segment 110 and second internal bore 230 of female pipe segment 102 form a continuous bore through which a fluid may flow. Depending on the pressure applied, the fluid and any particles therein (such as proppant particles in a fracturing fluid) may disadvantageously escape internal bores 230, 295 and travel along a boundary 315 between outer surface 285 of male pipe segment 110 and first circumferential inner surface 210 of female pipe segment 102. To prevent this, particulate shield 126 and sealing members 118, 118′ are provided. Particulate shield 126 is positioned within particulate groove 124 of male pipe segment 110 to prevent fluid particles (such as proppant particles) from traveling along boundary 315, and sealing members 118, 118′ (which may include, for example, polymers, metals, or combinations thereof) are positioned within annular sealing grooves 120, 120′ of female pipe segment 102 to prevent the fluid itself from escaping to the outside environment along boundary 315. Although expandable pipe spool 100 is illustrated with two sealing members 118, 118′, it should be appreciated that other embodiments may include fewer or more sealing members 118, and that various embodiments of the subject disclosure are not intended to be limited to any particular number of sealing members 118. It should also be appreciated that other embodiments may employ more than one particulate shield 126 or no particulate shield 126 at all.

When the pressure applied to the fluid is substantially high, such as when the fluid is a high-pressure fracturing fluid used in a fracturing operation, sealing members 118, 118′ may be insufficient alone to prevent the fluid from escaping along boundary 315 to the environment. To address this, in accordance with various embodiments of the subject disclosure, a second pressurized hydraulic fluid (such as an oil-based fluid) is introduced into fluid ports 255, 255′, where it then flows through fluid conduits 245, 245′ and into sealing grooves 120, 120′. As shown best in FIG. 4b, the pressurized hydraulic fluid urges sealing members 118, 118′ against outer surface 285 of male pipe segment 110, thereby improving the seal provided by sealing members 118, 118′. The effectiveness of the improved seal may be tested by checking whether pressurized hydraulic fluid flows disadvantageously from sealing grooves 120, 120′, along boundary 315, through test conduit 262 and out test port 265. Detection of hydraulic fluid at test port 265 may indicate failure of pressurized seals 118, 118′.

The pressurized hydraulic fluid may be drained from sealing grooves 120, 120′ via drainage conduits 250, 250′ and drainage ports 260, 260′. Drainage of the hydraulic fluid may be required, for example, to service expandable pipe spool 100 or when the seal provided by sealing members 118, 118′ under pressure is too great to permit male pipe segment 110 to be slid to a selected longitudinal position relative to female pipe segment 102 for changing the length of expandable pipe spool 100.

It will be appreciated by those skilled in the art that changes could be made to the exemplary embodiments described above without departing from the broad inventive concept thereof. It is to be understood, therefore, that this disclosure is not limited to the particular embodiments disclosed, but it is intended to cover modifications within the spirit and scope of the subject disclosure as defined by the appended claims.

I/We claim:

1. An expandable pipe spool comprising:
a female pipe segment having an outer surface and an inner surface having at least one sealing groove;
at least one fluid port on the outer surface of the female pipe segment for receiving a hydraulic fluid, the fluid port in fluid communication with the sealing grove;
a male pipe segment having an outer surface receivable within the female pipe segment;
a sealing member positioned within the sealing groove between the inner surface of the female pipe segment and the outer surface of the male pipe segment; and
a fastening arrangement to lock the male pipe segment in a selected longitudinal position with respect to the female pipe segment.

2. The expandable pipe spool of claim 1, wherein the inner surface of the female pipe segment includes a first circumferential inner surface defining a first internal bore and a second circumferential surface defining a second internal bore, the second internal bore having a second diameter smaller than a first diameter of the first internal bore.

3. The expandable pipe spool of claim 1, wherein the at least one sealing groove includes two sealing grooves.

4. The expandable pipe spool of claim 1, wherein the female pipe segment incudes an end provided with fastening holes, the fastening holes being sized to receive fasteners to connect the female pipe segment to a component.

5. The expandable pipe spool of claim 1, wherein the male pipe segment includes a flange portion to engage with the fastening arrangement.

6. The expandable pipe spool of claim 5, wherein the fastening arrangement includes at least one fastening stud extending through the flange portion of the male pipe segment and connected rigidly at an end of the female pipe segment.

7. The expandable pipe spool of claim 6, wherein the fastening arrangement further includes first and second nuts positioned on the fastening stud on respective sides of the flange portion of the male pipe segment.

8. The expandable pipe spool of claim 2, wherein the male pipe segment includes an internal bore having a diameter approximately equal to the second diameter of the second internal bore of the female pipe segment.

9. The expandable pipe spool of claim 1, wherein the male pipe segment is structured to slidingly engage with the female pipe segment.

10. The expandable pipe spool of claim 1, wherein a seal provided by the sealing member is improved when the hydraulic fluid flows under pressure from the fluid port into the sealing groove.

11. The expandable pipe spool of claim 1, wherein the sealing member includes a polymer, a metal, a composite or combinations thereof.

12. The expandable pipe spool of claim 1, further comprising a particulate shield between the inner surface of the female pipe segment and the outer surface of the male pipe segment.

13. The expandable pipe spool of claim 12, wherein the outer surface of the male pipe segment is provided with a particulate groove, the particulate shield positioned within the particulate groove.

14. The expandable pipe spool of claim 1, further comprising at least one drainage port on the outer surface of the female pipe segment for draining the hydraulic fluid, the drainage port in fluid communication with the sealing groove.

15. The expandable pipe spool of claim 1, wherein the sealing member is an annular sealing member.

16. A method of adjusting a length of the expandable pipe spool of claim 1, comprising:
inserting the male pipe segment within the female pipe segment;
sliding the male pipe segment to the selected longitudinal position with respect to the female pipe segment;
employing the fastening arrangement to lock the male pipe segment in the selected longitudinal position with respect to the female pipe segment; and
injecting the hydraulic fluid into the sealing port to urge the sealing member against the outer surface of the male pipe segment to improve a seal between the male pipe segment and the female pipe segment.

17. The method of claim 16, wherein the expandable pipe spool further includes a particulate shield between the inner surface of the female pipe segment and the outer surface of the male pipe segment.

18. The method of claim 17, wherein the outer surface of the male pipe segment includes a particulate groove, the particulate shield being positioned within the particulate groove.

19. The method of claim 16 wherein the sealing member is an annular sealing member.

20. The method of claim 16, wherein the sealing member includes a polymer, a metal, a composite or combinations thereof.
